(19) United States
(12) Patent Application Publication
(10) Pub. No.: US 2026/0208887 A1
(43) Pub. Date: Jul. 23, 2026

(54) RESETTABLE HOLD DOWN AND RELEASE MECHANISM INCLUDING ROLLER LOCKS

(71) Applicant: Ensign-Bickford Aerospace & Defense Company, Simsbury, CT (US)

(72) Inventor: Luke K. Ionno, Colchester, CT (US)

(21) Appl. No.: 19/451,025

(22) Filed: Jan. 16, 2026

Related U.S. Application Data
(60) Provisional application No. 63/746,393, filed on Jan. 17, 2025.

(51) Int. Cl. B64G 1/64

(52) U.S. Cl. CPC B64G 1/6457

(57) ABSTRACT

A resettable hold down and release mechanism includes a carriage body defining a receiving space, a carriage trigger positioned within the receiving space and being movable between a loaded position and an unloaded position, a catch arm positioned within the receiving space and being movable between a locked position and a released position, a carriage spring positioned within the receiving space and biasing the carriage trigger from the loaded position toward the unloaded position, and a release fitting selectively coupled with the carriage body via the catch arm. The release fitting is selectively released from the carriage body. The release fitting is reattachable to the carriage body for reuse.

### CROSS-REFERENCE TO RELATED APPLICATIONS

This application claims the benefit of U.S. Provisional Patent Application No. 63/746,393, filed on January 17, 2025. The entire contents of the aforementioned applications are incorporated herein by reference.

### BACKGROUND

The subject matter disclosed herein relates in general to hold down and release systems, and more particularly to stage separation systems for use on rocket staging mechanisms or other spacecraft.

Components of a launch vehicle may need to be separated during flight to jettison stages and components that are no longer needed, to uncover equipment, or release a payload into orbit for example. Components of a launch vehicle may also need to be separated to deploy payloads. Once the launch vehicle reaches a destination or desired orbit characteristic, then payload satellites, probes, or other payloads can be deployed and placed into a functioning mode. Payloads, for example satellites, can be carried by launch systems, such as space vehicles, into orbit or other destinations in space. Satellites can be placed into Earth orbit (or into orbit around other bodies) to perform various tasks, such as sensing, surveillance, communications, or scientific experimentation.

Existing mechanisms or systems for holding and releasing preloaded items (e.g., vehicles stages, rocket stages, satellites, etc.) in flight exhibit several drawbacks. For instance, existing release mechanisms incorporate complex actuator assemblies involving a plurality of moving parts, increasing the potential for undesirable results or malfunctions. Moreover, existing release systems can be difficult to reuse by incorporating non-resettable features or requiring the assembly to be rebuilt in order to be reused.

Accordingly, a payload release system which obviates one or more of the above-mentioned drawbacks would be beneficial. In particular, a payload release system having the features described herein would be useful.

### BRIEF DESCRIPTION

According to one aspect of the disclosure, a resettable hold down and release mechanism is provided. The hold down and release mechanism may include a carriage body defining a receiving space; a carriage trigger positioned within the receiving space, the carriage trigger being movable between a loaded position and an unloaded position; a catch arm positioned within the receiving space, the catch arm being movable between a locked position and a released position, wherein the catch arm is operably coupled with the carriage trigger; a carriage spring positioned within the receiving space, the carriage spring biasing the carriage trigger from the loaded position toward the unloaded position; and a release fitting selectively coupled with the carriage body via the catch arm.

According to another aspect of the present disclosure, a method of operating a hold down and release mechanism is provided. The hold down and release mechanism may include a carriage body, a carriage trigger within the carriage body, a pair of catch arms within the carriage body and operably coupled with the carriage trigger, and a release fitting selectively restrained against the carriage body via the pair of catch arms. The method may include positioning the release fitting against the carriage body; moving the carriage trigger from an unloaded position to a loaded position after positioning the release fitting against the carriage body such that each of the pair of catch arms moves to a loaded position; and restraining the carriage trigger in the loaded position via a release mechanism positioned outside of the carriage body.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 provides a perspective view of a hold down and release mechanism with a release fitting in an attached position according to exemplary embodiments of the present disclosure.

FIG. 2 provides a perspective view of the exemplary hold down and release mechanism of FIG. 1 with the release fitting in a detached position.

FIG. 3 provides a front view of the exemplary hold down and release mechanism of FIG. 1 with a front carriage body removed and a carriage trigger in a loaded position.

FIG. 4 provides a front view of the exemplary hold down and release mechanism of FIG. 3 with the carriage trigger in an unloaded position.

FIG. 5 provides a close-up front view of the exemplary hold down and release mechanism of FIG. 1 with a preload fitting in a first position.

FIG. 6 provides a close-up front view of the exemplary hold down and release mechanism of FIG. 1 with the preload fitting in a second position.

FIG. 7 provides a flow chart illustrating a method of operating a hold down and release mechanism according to exemplary embodiments of the present disclosure.

### DETAILED DESCRIPTION

Embodiments disclosed herein provide for payload launch release or vehicle stage release mechanisms.

Generally, release mechanisms (e.g., hold down and release mechanisms) for vehicles such as rockets may include non-explosive actuators (NEA) such as NEAs manufactured by Ensign Bickford Aerospace and Defense (EBAD) located in Simsbury, CT. These prior art mechanisms secure the payload to the launch vehicle. However, these mechanisms can only be used once. In some instances, it is desirable to provide a release mechanism that is field-resettable. This provides advantages in allowing the release mechanisms to be tested prior to launch for example. As with the NEA devices, some embodiments of the present disclosure may employ a split spool to release a preloaded axial component (the release rod), when voltage/current is supplied to the device. The overall form-factor and preload capacity versus device volume of the disclosed embodiments for the launch/stage release mechanisms are also comparable those of an NEA.

According to some embodiments, the trigger mechanism is driven by a titanium-nickel (TiNi) wire. In this respect, at least portions of the present disclosure may have similarities with the EBAD electric release mechanism (ERM) family of devices, such as U.S. Pat. No. 11,976,640 which is hereby incorporated by reference in its entirety; however, it offers significantly higher preload for a given size/volume.

Embodiments of the present disclosure are configured to release payloads or vehicle stages retained by a preload release rod. For instance, the preload release rod may be coupled to a carriage. A release fitting may then be selectively or releaseably coupled to the carriage. One or more pivoting arms may be included within the carriage and configured to restrain the release fitting in a loaded position. Upon a release activation at the preload release rod, the arms may pivot from a first position to a second position. Latch features on the arms may then move away from restraining ledges of the release fitting to allow the release fitting to eject away from the carriage, as will be explained.

In some instances, the release fitting (or a new release fitting) may be reconnected or reloaded onto the carriage for reuse. A reload feature or operation may be performed to reattach the release fitting to the carriage, thus providing reusability of the release mechanism.

According to some embodiments, the present disclosure may carry or restrain substantial flight loads during a first stage rocket burn without gapping or loss of preload. Being able to achieve large axial load capability is desirable; one embodiment design is sized for a 100,000 lb. axial preload. The flat form-factor of the disclosure may be intended to provide a direct load path to the skin of a monocoque structure, while introducing reduced or minimal out-of-plane bending to the skin, and reducing or minimizing any external protrusions which could interfere with vehicle aerodynamics. In an embodiment, shear loads would be predominantly in-plane (with respect to the flat form-factor), and would be carried either by the main body or carriage of the disclosure, or by separate shear reaction features, either integrated into the disclosure, or mounted separately.

Additionally or alternatively, a difference between the present disclosure and other staging/large hold down and release mechanisms (such as frangible joints or separation bolts) is that the latter are single-use devices. While a variety of resettable load release mechanisms are available, many of these are generally too small to be used as stage separation mechanisms directly. The present disclosure allows a similar concept of operation as these smaller devices, but at a scale suitable for staging. Yet another advantage of the present disclosure is that compared to traditional pyrotechnic stage separation devices, it is expected to produce significantly less source shock when actuated.

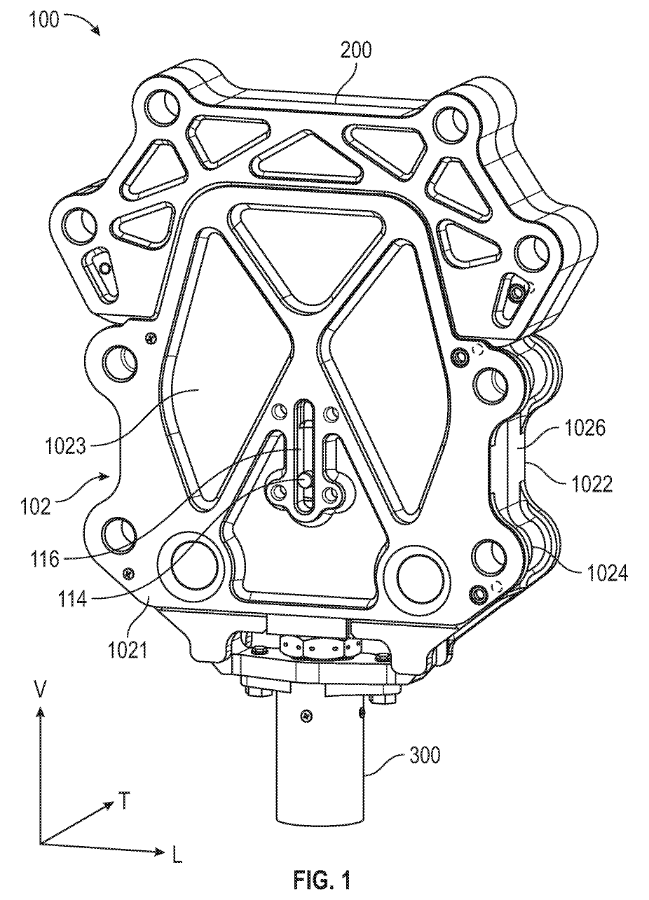

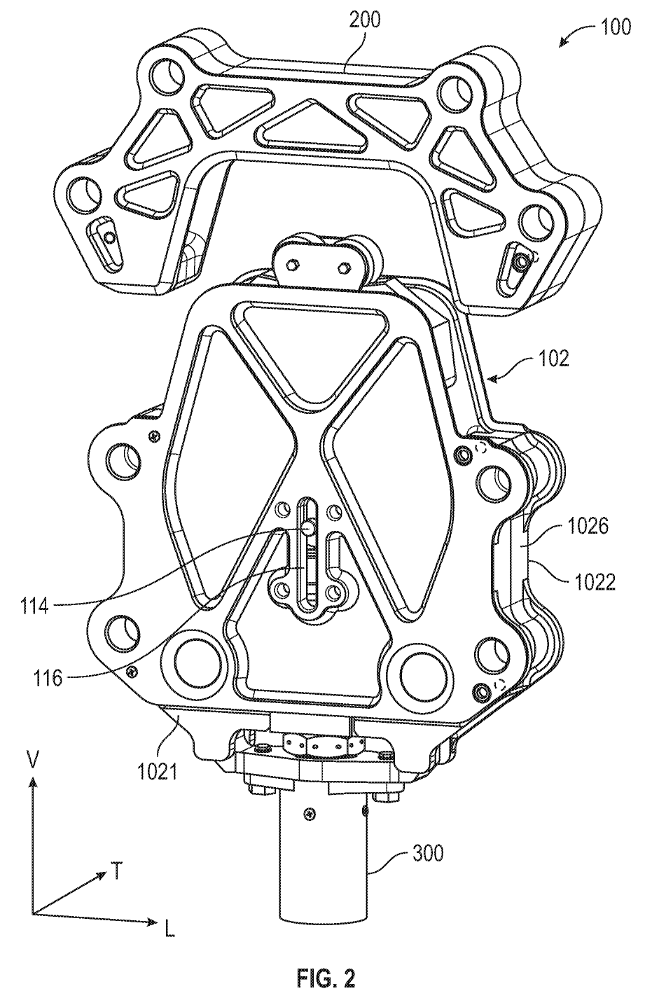

Referring now to the figures, FIGS. 1 and 2 provide perspective views of a resettable hold down and release mechanism (HDRM) 100 according to exemplary embodiments of the present disclosure. For instance, FIG. 1 shows HDRM 100 with a release fitting 200 in an attached or coupled position while FIG. 2 shows HDRM 100 with release fitting 200 in a detached or decoupled position. As will be explained, release fitting 200 may be selectively coupled to a carriage body 102. Carriage body 102 may be attached to a first element (e.g., a craft, vehicle, vehicle stage, etc.) while release fitting 200 may be attached to a second element (e.g., satellite, vehicle stage, instrument, etc.). Thus, release fitting 200 may be configured to eject or detach from carriage body 102 at a predetermined instance to detach the second element from the first element. For purposes of this discussion, HDRM 100 may define a vertical direction V, a lateral direction L, and a transverse direction T. It should be understood that these directions are provided by way of example and reference only, and that HDRM 100 may be orientated in any suitable direction, plane, or coordinate system.

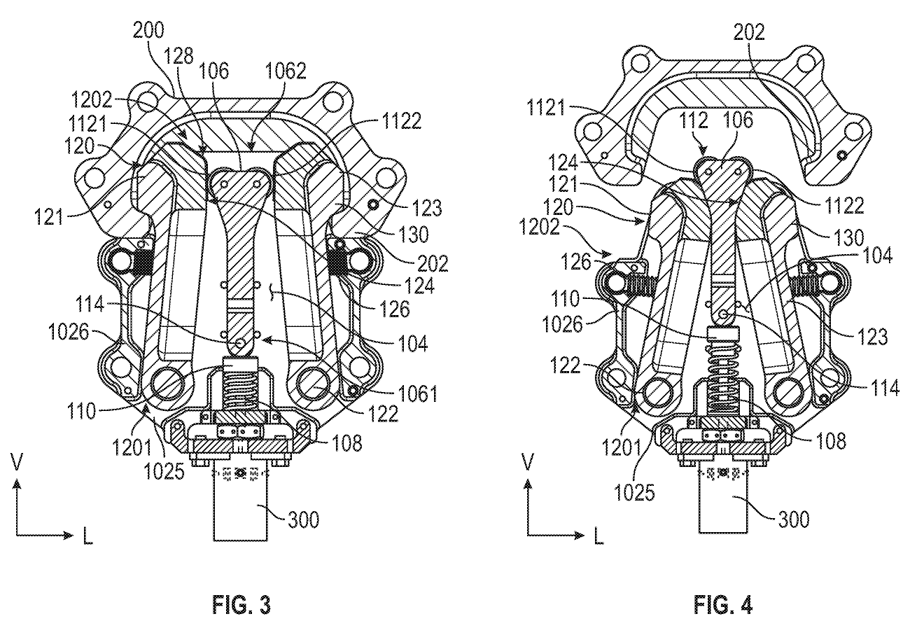

Referring now to FIG. 3 and FIG. 4 with continuing reference to FIG. 1 and FIG. 2, HDRM 100 may include carriage body 102. Carriage body 102 may define a receiving space 104. For instance, carriage body 102 may include a first portion 1021 and a second portion 1022 configured to be connected to first portion 1021. First portion 1021 may include a plate portion 1023 and a wall portion 1024 extending from plate portion 1023. For instance, plate portion 1023 may extend along the vertical direction V and the lateral direction L. Thus, wall portion 1024 may protrude from plate portion 1023 along the transverse direction T. Similarly, second portion 1022 may include a plate portion 1025 and a wall portion 1026 extending from plate portion 1025. Wall portion 1024 and wall portion 1026 may mate against each other to define receiving space 104 between plate portion 1023 and plate portion 1025. Additionally or alternatively, each of wall portion 1024 and wall portion 1026 may extend substantially along the vertical direction V. As such, at least a portion of receiving space 104 may be exposed (e.g., outward) between plate portion 1023 and plate portion 1025.

HDRM 100 may include a carriage trigger 106. Carriage trigger 106 may be positioned within receiving space 104. Carriage trigger 106 may be movably (e.g., slidably) received within receiving space 104. For instance, carriage trigger 106 may be movable between a loaded position (e.g., FIGS. 1 and 3) and an unloaded position (e.g., FIGS. 2 and 4). In detail, when in the loaded position, carriage trigger 106 may be in a downward position. Accordingly, when in the unloaded position, carriage trigger 106 may be in an upward position.

Carriage trigger 106 may be elongated substantially along the vertical direction V. Similarly, carriage trigger 106 may be configured to slide primarily along the vertical direction V (e.g., between the loaded position and the unloaded position). Carriage trigger 106 may define a proximal end 1061 and a distal end 1062. Proximal end 1061 may be positioned at or near a bottom of HDRM 100. Accordingly, distal end 1062 may be positioned at or near a top of HDRM 100.

Carriage trigger 106 may be biased along the vertical direction V. For instance, HDRM 100 may include a carriage spring 108. Carriage spring 108 may be positioned within receiving space 104. In some instance, carriage spring 108 is provided at or near the bottom of HDRM 100. Carriage spring 108 may be operably coupled with carriage trigger 106. In detail, carriage spring 108 may contact proximal end 1061 of carriage trigger 106. Carriage spring 108 may accordingly bias carriage trigger 106 along the vertical direction V from the loaded position toward the unloaded position.

Carriage spring 108 may be or include any suitable elastic or resilient member such as a coil compression spring. However, it should be understood that any suitable resilient member capable to biasing carriage trigger 106 may be included or utilized as carriage spring 108. Carriage spring 108 may thus be energized when carriage trigger 106 is in the loaded position (e.g., as seen in FIG. 3).

According to some embodiments, HDRM 100 may include a release pin 110. Release pin 110 may be operably coupled with carriage trigger 106. For instance, release pin 110 may be provided in contact with proximal end 1061 of carriage trigger 106. Thus, release pin 110 may be operably coupled with carriage spring 108. For instance, release pin 110 may be selectively urged or moved via carriage spring 108 in response to an input. In some instances, release pin 110 is positioned within carriage spring 108 (e.g., as shown in FIGS. 3 and 4). Additionally or alternatively, release pin 110 may extend through the bottom of carriage body 102 along the vertical direction V.

HDRM 100 may include an electrical release mechanism (ERM) 300. ERM 300 may be selectively or operably coupled with release pin 110. As mentioned, release pin 110 may extend to an outside of receiving space 104. Thus, release pin 110 may be selectively restrained via ERM 300 (e.g., along the vertical direction V). ERM 300 may be or include any suitable release mechanism. For instance, ERM 300 may include a latch, hook, element, or the like that is configured to release release pin 110 at a predetermined time or according to an input signal. In some instance, ERM 300 include a shape-memory alloy wire configured to change shape in response to an electrical input. Thus, when ERM 300 is activated, release pin 110 may be released, and carriage spring 108 may push or move carriage trigger 106 toward the unloaded position.

Carriage trigger 106 may include a rolling element 112. In detail, carriage trigger 106 may include one or more rollers or wheels configured to rotate with respect to carriage trigger 106. In at least some instances, carriage trigger 106 includes two rolling elements 112, however, the disclosure is not limited to the examples provided herein. Rolling element 112 may be positioned at distal end 1062 of carriage trigger 106. As shown particularly in FIG. 3, rolling element 112 may be exposed through carriage trigger 106 along each of the lateral direction L and the vertical direction V.

In the instance where two rolling elements 112 are provided, the rolling elements 112 may be provided adjacent to each other along the lateral direction L (e.g., side-by-side). For instance, a first rolling element 1121 and a second rolling element 1122 may be rotatably coupled to carriage trigger 106. In some instances, first rolling element 1121 and second rolling element 1122 are in contact with each other (e.g., along the lateral direction L). Thus, first rolling element 1121 and second rolling element 1122 may roll or rotate together (e.g., as carriage trigger 106 is moved from the loaded position to the unloaded position).

Carriage trigger 106 may include a guide pin 114. Guide pin 114 may protrude or extend from carriage trigger 106 along the transverse direction T. For instance, guide pin 114 may extend toward carriage body 102 (e.g., toward plate portion 1023 or plate portion 1025). Guide pin 114 may be received within a guide slot 116. Guide slot 116 may be formed in carriage body 102 (e.g., within plate portion 1023 or plate portion 1025). As shown particularly in FIGS. 1 and 2, guide slot 116 may extend predominantly along the vertical direction V. Thus, guide pin 114 may be configured to translate within guide slot 116 along the vertical direction V as carriage trigger 106 translates along the vertical direction V between the loaded position and the unloaded position.

HDRM 100 may include a catch arm 120. Catch arm 120 may be positioned within receiving space 104. Catch arm 120 may be movable within receiving space 104. For instance, catch arm 120 may be movable between a locked position (e.g., FIG. 3) and a released or unlocked position (e.g., FIG. 4). Catch arm 120 may define a pivot end 1201 and a free end 1202 opposite pivot end 1201. Accordingly, catch arm 120 may pivot about pivot end 1201 between the locked position and the released position. In some instances, a pivot pin 122 is provided at pivot end 1201. Thus, catch arm 120 may pivot about pivot pin 122.

Catch arm 120 may be operably coupled with carriage trigger 106. In detail, catch arm 120 may be selectively moved between the locked position and the released position via a movement of carriage trigger 106. For instance, rolling element 112 may selectively roll along catch arm 120 as carriage trigger 106 moves from the loaded position to the unloaded position. When carriage trigger 106 is in the loaded position, catch arm 120 may be restrained in the locked position. For instance, when in the locked position, free end 1202 may be positioned laterally outward from a center point or center line of carriage body 102.

Free end 1202 may include or define a roller contact surface 124. Roller contact surface 124 may extend predominantly along the vertical direction V and along the transverse direction T. Thus, rolling element 112 may be selectively in contact (e.g., rolling contact) with roller contact surface 124. As mentioned, carriage trigger 106 may restrain catch arm 120 in the locked position when in the loaded position. Thus, as carriage trigger 106 moves from the loaded position to the unloaded position, rolling element 112 may roll along rolling contact surface 124. Catch arm 120 may thus move (e.g., rotate, pivot, etc.) from the locked position to the released position. When in the released position, free end 1202 may be moved laterally inward toward the center of carriage body 102.

HDRM 100 may include a biasing member, such as kickoff spring 126. Kickoff spring 126 may be operably coupled between catch arm 120 and carriage body 102. For instance, kickoff spring 126 may be coupled at wall portion 1024 or wall portion 1026 of carriage body 102. Thus, kickoff spring 126 may selectively bias catch arm 120 toward the released position (e.g., toward carriage trigger 106). As carriage trigger 106 moves from the loaded position to the unloaded position, rolling element 112 rolls along roller contact surface 124. At a breaking point 128 of roller contact surface 112, catch arm 120 (e.g., free end 1202) may be moved inward.

Referring briefly to FIG. 3, catch arm 120 is shown in the locked position and carriage trigger 106 is shown in the loaded position. When in the locked position, roller contact surface 124 may extend along a predetermined direction. For instance, roller contact surface 124 may extend at a predetermined angle with respect to the vertical direction V. In detail, roller contact surface 124 may extend at an acute angle with respect to the vertical direction V. Roller contact surface 124 may thus form or define a self-releasing feature such that upon release by ERM 300, carriage trigger 106 (via rolling element(s) 112) may be pre-induced to roll upward along roller contact surface 124, allowing free end 1202 of catch arm 120 to rotate or pivot inward (e.g., toward the released position).

Catch arm 120 may include or define a catch ledge 130. Catch ledge 130 may be defined or provided at free end 1202. Catch ledge 130 may be configured to selectively restrain release fitting 200 against carriage body 102. For instance, when catch arm 120 is in the locked position, catch ledge 130 may be interlocked with at least a portion of release fitting 200. As shown particularly in FIG. 3, release fitting 200 may define a flange portion 202. Flange portion 202 may extend or protrude inward predominantly along the lateral direction L. Catch ledge 130 may thus selectively contact and restrain release fitting 200 against carriage body 102 (e.g., when catch arm 120 is in the locked position).

When catch arm 120 is in the locked position, a contact face of catch ledge 130 may extend at a predetermined angle with respect to the lateral direction L. For instance, referring again to FIG. 3, the angle between catch ledge 130 and the lateral direction L may be an acute angle. According to at least some embodiments, the angle between catch ledge 130 and the lateral direction L is between about 10 degrees and about 25 degrees. Additionally or alternatively, a contact point between catch ledge 130 and release fitting 200 (e.g., flange portion 202) may be laterally offset from the pivot point of catch arm 120. For instance, the contact point may be provided laterally outward from the pivot point. Advantageously, when carriage trigger 106 moves from the loaded position to the unloaded position, catch arm 120 (e.g., at catch ledge 130) may be induced to rotate inward away from flange portion 202 to allow release fitting 200 to eject from carriage body 102.

HDRM 100 may include a plurality of catch arms 120. For instance, as shown in FIGS. 3 and 4, HDRM 100 may include a first catch arm 121 and a second catch arm 123. First catch arm 121 may be positioned on or at a first lateral side of carriage trigger 106 while second catch arm 123 may be position on or at a second lateral side of carriage trigger 106 (e.g., opposite first catch arm 121). Additionally or alternatively, as mentioned, first rolling element 1121 may be in rolling contact with first catch arm 121 and second rolling elements 1122 may be in rolling contact with second catch arm 123. Second catch arm 123 may be substantially similar to first catch arm 121 (e.g., including a pivot end, a free end, a catch ledge, a rolling contact surface, etc.). Accordingly, a detailed description will be foregone for the sake of brevity and with the understanding that the above description of catch arm 120 may apply to each of first catch arm 121 and second catch arm 123.

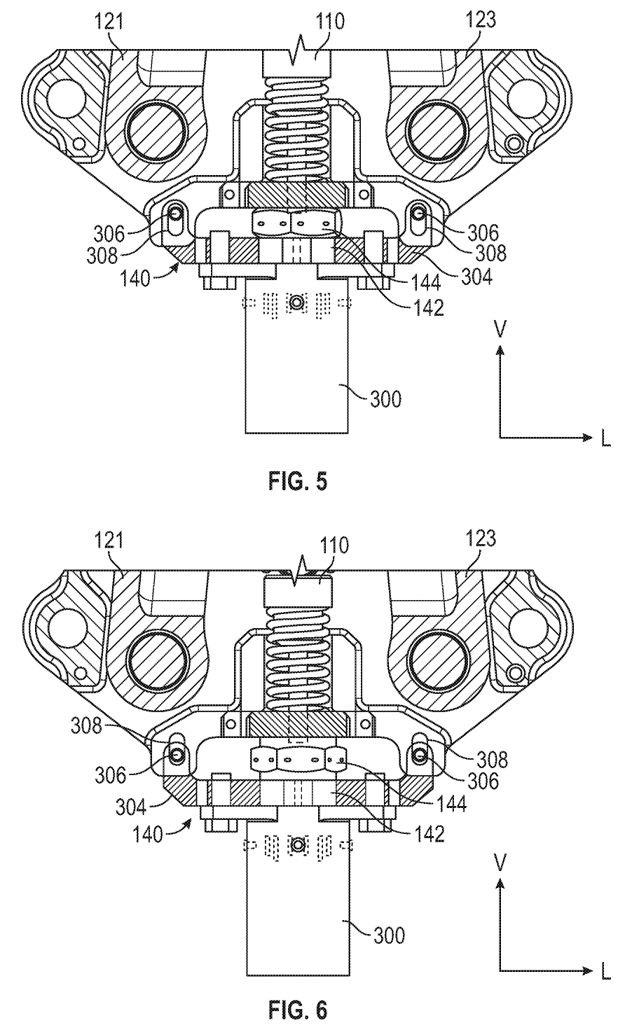

HDRM 100 may include a preload fitting 140. For instance, ERM 300 may be selectively coupled to preload fitting 140 (e.g., at or near the bottom of carriage body 102) as shown in FIG. 5. Preload fitting 140 may include a lead screw 142 and an adjustment nut 144 operably coupled to lead screw 142. Thus, adjustment nut 144 may be rotated to either lift or lower carriage body 102 with respect to lead screw 142 and subsequently with respect to ERM 300. FIG. 5 provides a front view of preload fitting 140 in a first position while FIG. 6 provides a front view of preload fitting 140 in a second position. As shown, a distance between carriage body 102 and ERM 300 may be adjusted by turning adjustment nut 144.

Preload fitting 140 may be operably connected with release pin 110. As mentioned above, release pin may also be in contact with carriage trigger 106 (e.g., at proximal end 1061 thereof). As such, when preload fitting (e.g., adjustment nut 144) is adjusted, carriage body 102 may be moved or adjusted with respect to carriage trigger 106. Accordingly, a location of rolling elements 112 with respect to catch arms 120 may be adjusted to create a preload force prior to actuation of HDRM 100.

ERM 300 may include a mounting fitting 304. Mounting fitting 304 may allow for an adjustment (e.g., along the vertical direction V) between ERM 300 and carriage body 102 (e.g., via preload fitting 140). As shown in FIGS. 5 and 6, mounting fitting 304 may include a pair of pins 306 extending along the transverse direction T. The pair of pins 306 may be respectively accepted within grooves or slots 308 formed in carriage body 102 (e.g., at or near the bottom thereof). The grooves or slots 308 may be elongated along the vertical direction V. Thus, as preload fitting 140 (e.g., adjustment nut 144) is adjusted, carriage body 102 may move along the vertical direction V with respect to mounting fitting 304. In turn, carriage trigger 106 may be adjusted along the vertical direction V with respect to catch arms 120.

As mentioned carriage trigger 106 may be configured to move or slide along the vertical direction V with respect to carriage body 102. Moreover, release fitting 200 may be configured to eject away from carriage body 102 along the vertical direction V. According to at least some embodiments, the movement direction of release fitting 200 is the same as the movement direction of carriage trigger 106. For instance, as carriage trigger 106 moves upward along the vertical direction V, release fitting 200 is also released upward along the vertical direction V.

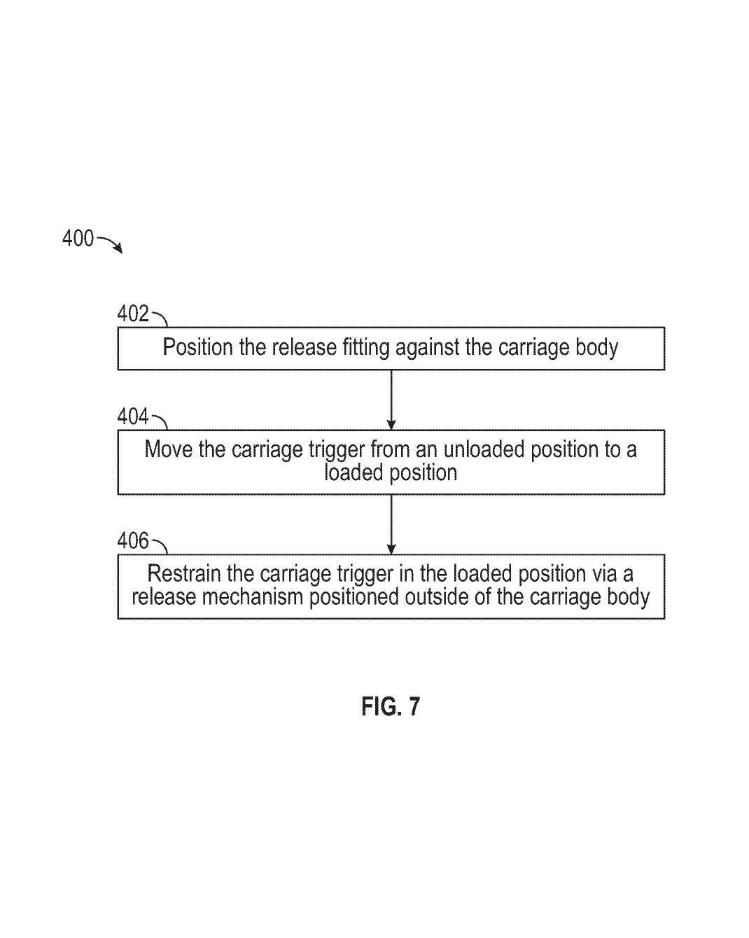

Now that the general description of a resettable hold down and release mechanism has been described in detail, a method 400 of operating a payload release system (e.g., including HDRM 100) will be described. Method 400 may be applicable to any suitable release mechanism or system, including HDRM 100 described above. The method steps described herein may be performed in any suitable order and the disclosure is not limited to the examples provided herein. Additionally or alternatively, steps may be added or omitted from method 400 as specific applications warrant. Hereinafter, method 400 will be described with reference to FIG. 7.

At 402, method 400 may include positioning the release fitting against a carriage body. In detail, the release fitting (e.g., release fitting 200) may be coupled to an element or instrument to be selectively detached from a vehicle, as mentioned above. The release fitting may be pressed into a predetermined location on the carriage body (e.g., carriage body 102). For instance, with brief reference to FIGS. 1 and 2, the release fitting may be pushed onto a lobe of the carriage body.

At 404, method 400 may include moving a carriage trigger from an unloaded position to a loaded position. After positioning the release fitting with respect to the carriage body, the carriage trigger (e.g., carriage trigger 106) may be adjusted, slid, or otherwise moved from the unloaded position (e.g., FIGS. 2 and 4) to the loaded position (e.g., FIGS. 1 and 3). The carriage trigger may include a guide pin (e.g., guide pin 114). For instance, as mentioned, the guide pin may be exposed through the carriage body. Thus, the carriage trigger may be adjusted by moving the guide pin along a guide slot (e.g., guide slot 116) formed in the carriage body. According to at least some embodiments, a tool such as a key, a wrench, or the like may be used to move the guide pin. Thus, for example, the guide pin is moved from a first position associated with the unloaded position to a second position associated with the loaded position.

At 406, method 400 may include restraining the carriage trigger in the loaded position. For instance, after moving the carriage trigger to the loaded position, one or more catch arms (e.g., catch arms 120) may be moved from a released position to a locked position. Accordingly, the catch arms may restrain or hold the release fitting against the carriage body. As mentioned, the carriage trigger may be operably coupled with the catch arms such that as the carriage trigger is moved to the loaded position, the catch arms are moved to the locked position. The carriage trigger may also be connected with an electric or electronic release mechanism (e.g., ERM 300). The ERM may maintain the carriage trigger in the loaded position, thus in turn maintaining the catch arms in the locked position.

According to some embodiments, method 400 may include receiving an input signal to activate the release mechanism (e.g., the ERM). The input signal may be an automatic or manual signal to actuate the ERM. According to some embodiments,

the ERM includes an actuator such as a shape-memory allow restraining the carriage trigger in the loaded position. At a predetermined time or under a predetermined activation, the ERM may be initiated or activated.

Method 400 may include initiating a movement of the carriage trigger form the loaded position to the unloaded position. For instance, in response to activating the release mechanism, the trigger may be moved to the unloaded position such that the catch arms are free to move to the released position. Once in the released position, the release fitting may be free to move away from the carriage body. As mentioned above, the payload release system may be a resettable or reusable payload release system. Thus, the release fitting (e.g., the same release fitting or a new, different release fitting) may then be reattached to the carriage body, and the ERM may be reset such that the payload release system may be reused.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A resettable hold down and release mechanism defining a vertical direction, a lateral direction, and a transverse direction, the hold down and release mechanism comprising:
a carriage body defining a receiving space;
a carriage trigger positioned within the receiving space, the carriage trigger being movable between a loaded position and an unloaded position;
a catch arm positioned within the receiving space, the catch arm being movable between a locked position and a released position, wherein the catch arm is operably coupled with the carriage trigger;
a carriage spring positioned within the receiving space, the carriage spring biasing the carriage trigger from the loaded position toward the unloaded position; and
a release fitting selectively coupled with the carriage body via the catch arm.

2. The resettable hold down and release mechanism of claim 1, wherein the carriage trigger comprises:
a rolling element positioned at a distal end thereof, the rolling element configured to rotate with respect to the carriage trigger.

3. The resettable hold down and release mechanism of claim 2, wherein the rolling element selectively rolls along the catch arm as the carriage trigger moves from the loaded position to the unloaded position.

4. The resettable hold down and release mechanism of claim 2, wherein the catch arm defines a pivot end and a free end opposite the pivot end, the free end comprising a roller contact surface.

5. The resettable hold down and release mechanism of claim 4, wherein the roller contact surface extends at an acute angle with respect to the vertical direction when the catch arm is in the locked position and the carriage trigger is in the loaded position.

6. The resettable hold down and release mechanism of claim 4, wherein the catch arm defines a catch ledge provided at the free end, the catch ledge being configured to selectively restrain the release fitting against the carriage body when the catch arm is in the locked position.

7. The resettable hold down and release mechanism of claim 2, wherein the catch arm is a first catch arm, and wherein the resettable payload mechanism further comprises:
a second catch arm positioned within the receiving space, the second catch arm being operably coupled with the carriage trigger opposite the first catch arm.

8. The resettable hold down and release mechanism of claim 7, wherein the rolling element is a first rolling element in operable communication with the first catch arm, and wherein the resettable hold down and release mechanism further comprises:
a second rolling element in operable communication with the second catch arm.

9. The resettable hold down and release mechanism of claim 8, wherein the first rolling element and the second rolling element are in contact with each other.

10. The resettable hold down and release mechanism of claim 1, wherein the carriage trigger is configured to translate along the vertical direction between the loaded position and the unloaded position, and wherein the carriage trigger comprises a guide pin protruding therefrom along the transverse direction.

11. The resettable hold down and release mechanism of claim 10, wherein the guide pin is received within a guide slot formed in the carriage body.

12. The resettable hold down and release mechanism of claim 1, further comprising:
a kickoff spring member operably coupled between the catch arm and the carriage body, wherein the kickoff spring biases the catch arm toward the carriage trigger.

13. The resettable hold down and release mechanism of claim 1, further comprising:
a preload fitting operably coupled between the carriage body and the carriage trigger, wherein the preload fitting selectively adjusts a position of the carriage trigger with respect to the carriage body when the carriage trigger is in the loaded position.

14. The resettable hold down and release mechanism of claim 1, further comprising:
a release pin coupled to the carriage trigger and extending through a bottom of the carriage body along the vertical direction; and
an electrical release mechanism operably coupled with the release pin, the electrical release mechanism selectively restraining the release pin along the vertical direction when the carriage trigger is in the loaded position.

15. The resettable hold down and release mechanism of claim 1, wherein a movement direction of the carriage trigger from the loaded position to the unloaded position is the same as a movement direction of the release fitting from the carriage body.

16. A method of operating a payload release system, the payload release system comprising a carriage body, a carriage trigger within the carriage body, a pair of catch arms within the carriage body and operably coupled with the carriage trigger, and a release fitting selectively restrained against the carriage body via the pair of catch arms, the method comprising:
positioning the release fitting against the carriage body;
moving the carriage trigger from an unloaded position to a loaded position after positioning the release fitting against the carriage body such that each of the pair of catch arms moves to a loaded position; and
restraining the carriage trigger in the loaded position via a release mechanism positioned outside of the carriage body.

17. The method of claim 16, wherein the carriage trigger comprises a guide pin extending therefrom through the carriage body, the guide pin being slidable within a groove formed in the carriage body.

18. The method of claim 16, wherein each of the pair of catch arms comprises a respective catch ledge, and wherein each respective catch ledge is configured to contact a respective flange formed within the release fitting.

19. The method of claim 16, further comprising:
receiving an input signal to activate the release mechanism; and
initiating a movement of the carriage trigger from the loaded position to the unloaded position in response to activating the release mechanism.

20. The method of claim 16, wherein the payload release system further comprises:
a first roller in rolling contact with a first catch arm of the pair of catch arms; and
a second roller in rolling contact with a second catch arm of the pair of catch arms, wherein the first roller and the second roller are in rolling contact with each other.
